(19) United States
(12) Patent Application Publication
(10) Pub. No.: US 2010/0102571 A1
(43) Pub. Date: Apr. 29, 2010

(54) Manpower Power Generator

(76) Inventor: Fu-Hung YANG, Pingjhen City (TW)

Correspondence Address: HDLS Patent & Trademark Services, P.O. BOX 220746, CHANTILLY, VA, 20153-0746, US

(21) Appl. No.: 12/259,354

(22) Filed: Oct. 28, 2008

(51) Int. Cl. H02K 7/06

(52) U.S. Cl. 290/1 C

(57) ABSTRACT

A manpower power generator includes a hand pole set, a foot pole set, a linking pole set, a freewheel set, a power generator, a electrical-control apparatus, a battery, a seat sit, and a pedestal. The aforementioned configuration is driven by manpower to output the mechanical energy and to convert the mechanical energy into the electric energy by the electrical-control apparatus. The electric energy is provided as home electric power and is isolated from the power generated by the power station. By the wheel set, the manpower power generator is able to be moved conveniently, and is able to be set indoor or outdoor for kinds of buildings. During generating power, the user can also go in for physical training. Thus, it is able to gain two advantages by the manpower power generator.

### BACKGROUND OF THE INVENTION

1. Field of the Invention

The present invention relates to a manpower power generator. More particularly, the present invention relates to a manpower power generator, which is configured to operate independently and to generate the electric power for home-use. The manpower power generator is able to be moved conveniently to desired places for setting up. The manpower power generator is driven by the manpower to convert the energy generated by human exercise into electrical energy, and is easy to be installed. The manpower power generator is contributive to green power field and should be popularized to every family.

2. Descriptions of the Related Art

As the history moves from agriculture society to industry society, people rely on electric energy more and more. The electric energy has been applied widely in kinds of fields, such as home power, business power, industry power, road lamps, public area illumination, and electrically driven public facilities. The aforementioned applications take a lot of electric power. For example, when a person goes back home at night, he or she turns on light, air condition, or uses computer or other electric appliances, and all the appliances consume electric energy. It costs huge power rate, and makes heavy burdens on power plant and pollutes the environment. When the energy is consumed, the resources are consumed. Even more, the environment is polluted and many side effects occur, such as greenhouse effect, abnormal weather, El Nino, and acid rain.

Recent years, occident or the countries short of oil develop alternative energy, and kinds of natural resources are developed to be adapted in generating power. Alternative energy is characterized in no pollution, and no consumption. Particularly, wind energy and solar energy are widely developed. However, the wind energy and solar energy are not suitable in applying in home application as alternative energy. The issue needed to be considered first is that the two kinds of alternative energy need an installation place. The wind energy and solar energy apparatuses have to be placed outdoor for receiving energy in order to operate well.

However, households are usually in a building or in an apartment, and there is no suitable space for setting up the aforementioned apparatuses that are configured to convert natural energy into alternative energy.

In facing emergencies, such as natural disasters, sometimes the household power may be cut off. Using a backup power generator would use fuel and emit exhaust gas which may pollute environment. Of course, this kind of back power generator is not suitable in using indoor. For general household demands, the aforementioned power generating applications would be improved. The concept of driving mechanism by manpower for retrieving the mechanical energy and operating the power generating apparatuses for generating electric energy is advantaged. By the aforementioned concept, it is no need to retrieve natural resource for generating power, and the apparatuses can be operated without considering the weather. The manpower power generator can generate power independently and be set inside the household. More, the manpower power generator is characterized in no pollution, and no consumption of resources. The power generation method is suitable for general households and for people living in groups. The power generation method is easy to popularize.

The inventor considers improvement in view of the aforementioned drawbacks of the conventional products, and develops the present invention of manpower power generator that is able to replace the conventional power generator.

### SUMMARY OF THE INVENTION

The primary objective of the present invention is to provide a manpower power generator. The mechanism of the present invention is driven by the manpower. The mechanism is configured to output mechanical energy to operate power generating apparatus, and then the power generating apparatus generates power for supplying household power consumption. The manpower power generation is not limited by the natural environment and weather conditions, and applies manpower with proper mechanism to output electric energy.

Another objective of the present invention is to provide a manpower power generator. The manpower power generator is adapted to be set inside the space of a family without particular assistant equipments, and has not to be set up at an outdoor place. The manpower power generator of the present invention is advantaged in convenient movement, easy to be set up, disassembled, moved, replaced, maintained, or operated for emergency power supply. Besides, the mechanism of the present invention is driven by the manpower and is advantaged in generating power for household use at anytime.

The manpower power generator achieving the aforementioned objectives comprises the following devices.

The manpower power generator comprises a pedestal being configured to provide supporting and connection for posterior configuration, in which the pedestal has a power generating apparatus, a battery, a rotation axis base, and a seat position base. The pedestal is configured to support the weight of the present invention and to fix the present invention at a location.

The manpower power generator comprises a wheel set, being configured to be connected to the pedestal and a wheel axis via a linking pole. The wheel set is able to be placed below the present invention for convenient moving the present invention, and is able to be contained above the present invention for conveniently setting up the present invention and installation.

The manpower power generator comprises a foot pole set, in which a position axis is set at central portion of the foot pole set, and a linking pole set is connected to the position axis at an end thereof, a pulley is set at the position axis at another end thereof, and a hand pole set is provided with a guiding groove for guiding a sliding force, a pad is connected to the foot pole set at an upper end thereof, and the rotation axis base is connected to the pedestal at the terminal end thereof.

The manpower power generator comprises the hand pole set, being set adjacently to and outside the foot pole set, in which the hand pole set is provided with a holding portion at the upper end of the hand pole set and provided with a groove at the middle-down portion of the hand pole set, the groove is configured to provide space for a pulley to move forward and backward, the pulley is connected to the foot pole set, and the rotation axis base of the pedestal is connected to the hand pole set at the terminal end thereof. The end of the hand pole set is connected to the hand pole rotation axis of the pedestal.

The manpower power generator comprises a linking pole set, being made of a plurality of pole-end bearings and screwed poles, in which one end of the linking pole set is pivoted to a ratchet disk adjustable axis of the outside of a ratchet disk, and another end of the linking pole is pivoted to the foot pole set at the position axis thereof. The linking pole set is configured to convert linear operation into rotational operation for driving the ratchet disk.

The manpower power generator comprises a freewheel set, in which a freewheel transmission axis is pivoted to a bearing base of the pedestal. A ratchet axis is pivoted to the axis hole of the freewheel set. The ratchet toothlike parts on the interior side of the ratchet disk drives the freewheel to rotate, then a transmission belt set around an exterior rim of the freewheel is adapted to rotate the power generator for generating power.

The manpower power generator comprises the power generator, being set on the pedestal, in which the power generator is configured to drive a generator wheel of the power generator by the mechanical energy via a transmission belt. The rotator inside the power generator rotates to generate electric energy, and the electric energy is inputted into the battery for being stored after integration.

The manpower power generator comprises a electrical-control apparatus, being set next to the power generator for integrating the power generated by the power generator.

The manpower power generator comprises the battery, being set next to the power generator and controlled by the electrical-control apparatus, in which the battery is configured to store the electrical power converted from the mechanical energy, and the mechanical energy is generated by movement of the mechanism, and the battery is configured to provide power to electric equipments.

The manpower power generator comprises a seat set, being set on the pedestal via a expansion pole. The seat set is able to be adjusted upward, downward, forward, and backward to fit different users. The user can stand on the pads of the foot pole set to operate the apparatus of the present invention by the user's whole weight. The whole weight can be converted into the potential energy for outputting larger electric power. Once the user is tired, he or she can set on the seat and continuously operates the apparatus.

By the aforementioned structure, the present invention can be placed in household, and the seat set be adjusted to fit different members in a family. Thus, each member of the family can conveniently operate the present invention, and continuously generate enough electric energy for household use.

### BRIEF DESCRIPTION OF THE DRAWINGS

The drawings disclose an illustrative embodiment of the present invention which serves to exemplify the various advantages and objects hereof, and are as follows:

FIG. 1 shows a perspective diagram of the present invention;

FIG. 2A illustrates relative position diagram of the structure of the present invention;

FIG. 2B illustrates varied relative position diagram of the structure of the present invention;

FIG. 2C illustrates the top-viewed diagram of FIG. 2A;

FIG. 2D illustrates the top-viewed diagram of FIG. 2B;

FIG. 3A illustrates relative position diagram of the embodiment of the present invention;

FIG. 3B illustrates varied relative position diagram of the embodiment of the present invention;

FIGS. 4A, 4B, and 4C illustrate varied relative position diagrams of the embodiment of the present invention in different angle.

FIGS. 4D, 4E, and 4F illustrate the top-viewed diagrams of FIGS. 4A, 4B, and 4C respectively;

FIG. 5A illustrates relative position diagram of the second embodiment of the present invention;

FIGS. 5A, 5B, and 5C illustrate varied relative position diagrams of the second embodiment of the present invention in different angle; and

FIGS. 5D, 5E, and 5F illustrate the top-viewed diagrams of FIGS. 5A, 5B, and 5C respectively.

### DESCRIPTION OF THE PREFERRED EMBODIMENT

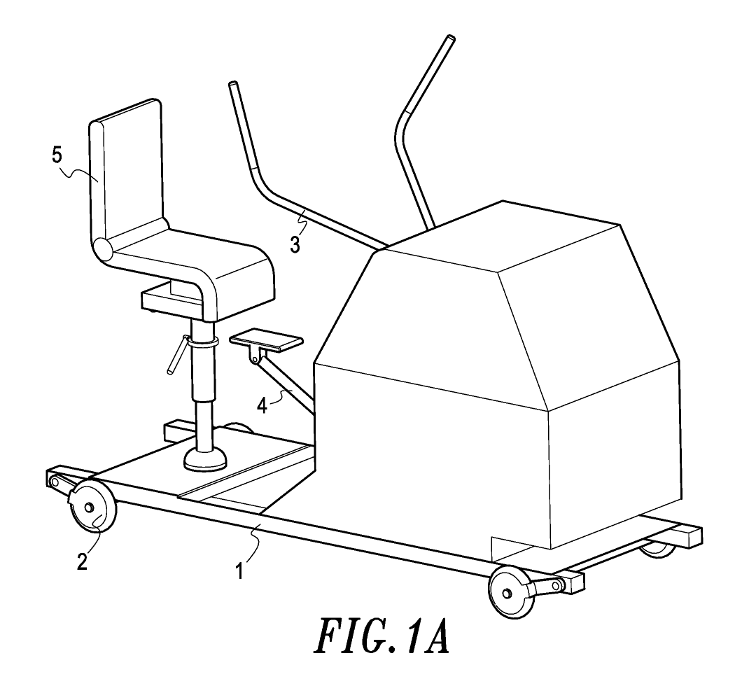

FIGS. 1A to 4G show diagrams of the manpower power generator of the present invention. Particularly, the mechanism of the present invention is driven by the manpower. The mechanism is configured to output mechanical energy to operate power generating apparatus, and then the power generating apparatus generates power. The manpower power generator of the present invention mainly comprises: a pedestal 1, a wheel set 2, hand pole sets 3R and 3L, foot pole sets 4R and 4L, a seat set 5, linking pole sets 6R and 6L, freewheel sets 7R and 7L, ratchet sets 8R and 8L, electrical-control apparatus 9, a battery 10, and a power generator 20. The moveable mechanisms of the present invention are set left-right symmetrically on the pedestal 1. The moveable mechanisms comprise the wheel set 2, hand pole sets 3R and 3L, foot pole sets 4R and 4L, a seat set 5, linking pole sets 6R and 6L, freewheel sets 7R and 7L, and ratchet sets 8R and 8L.

The pedestal 1 is configured to support the whole structure. The front end and the back end of the pedestal 1 are connected to the wheel set 2 for conveniently moving the present invention. When moving the present invention to a location, the wheel set 2 can be rotated upward for being placed on the pedestal 1, and the rubber pad at the bottom of the pedestal 1 is adapted to be placed on the ground for absorbing shock and noise, and against sliding during operation. The foot pole rotation axis bases 11R and 11L, and the hand pole rotation axis bases 17R and 17L, are set on the pedestal 1. The foot pole rotation axis bases 11R and 11L are pivoted to the ends of the foot pole sets 4R and 4L. The hand pole rotation axis bases 17R and 17L are pivoted to the ends of the hand pole sets 3R and 3L. The middle-down portions of the hand pole sets 3R and 3L are set with guiding grooves 32R and 32L respectively. The middle portions of the foot pole sets 4R and 4L are set with position axes 42R and 42L respectively. Linking pole sets 6R and 6L are pivoted to the interior sides of the position axes 42R and 42L respectively. Pulleys 43R and 43L are set on the exterior sides of the position axes 42R and 42L respectively. The pulleys 43R and 43L are set within the grooves 32R and 32L of the hand pole sets 3R and 3L respectively. The pulleys 43R and 43L are configured to receive effective force from the hand pole sets 3R and 3L and to drive the linking pole sets 6R and 6L respectively. The position axes 42R and 42L are configured to receive effective forces from the hand pole sets 3R and 3L, from the linking pole sets 6R and 6L, and from the foot pole sets 4R and 4L there between for driving the freewheel set. That is, the forces from the feet and hands of the user can be delivered via the linking pole sets 6R and 6L for driving the freewheel set.

The hand pole sets 3R and 3L are set at the exterior side of the foot pole sets 4R and 4L, and the linking pole sets 6R and 6L are set at the interior side of the foot pole sets 4R and 4L. The aforementioned three components are connected together via the position axes 42R and 42L on the foot pole sets 4R and 4L. When the user give force on the foot pole sets 4R and 4L, and give force on the hand pole sets 3R and 3L, the two kinds on forces concentrate on the position axes 42R and 42L and are transmitted to the linking pole sets 6R and 6L. The linking pole sets 6R and 6L have pole-end bearings 62R and 62L and screwed poles, and one end of the linking pole sets 6R and 6L are connected to the position axes 42R and 42L of the foot pole sets respectively, one end of the linking pole sets 6R and 6L are connected to the ratchet disk adjustable axes 83R and 83L respectively.

The bearing holder 13 is set on the pedestal 1. A bearing base 14 is screwed on the bearing holder 13. A freewheel transmission axes 72 is set inside of the bearing base 14 for being connected to the freewheel sets 7R and 7L and the ratchet disk sets 8R and 8L respectively. The power generator 20 is set on the pedestal 1. The freewheel sets 7R and 7L are connected to a generator wheel 23 via a transmission belt 18. The generator wheel 23 is on the front end of the axis of the power generator 20. The transmission belt 18 is selected from groups of: leather belts, chains, and gear wheels. Ratchet disk adjustable axes 83R and 83L are set on the exterior side of the ratchet disk sets 8R and 8L respectively. The ratchet disk adjustable axes 83R and 83L are directly connected to the linking pole sets 6R and 6L. The left and right ratchet disk sets 8R and 8L are set on an arbor, and the arbor is set inside the transmission axis 72 of the freewheel set, and is pivoted to a hole of the transmission axis 72. The hand pole holder 15 is screwed on the front portion of the bearing holder 13, and the hand pole holder 15 is configured to guild the upper portion of the hand pole sets 3R and 3L for moving forward and backward.

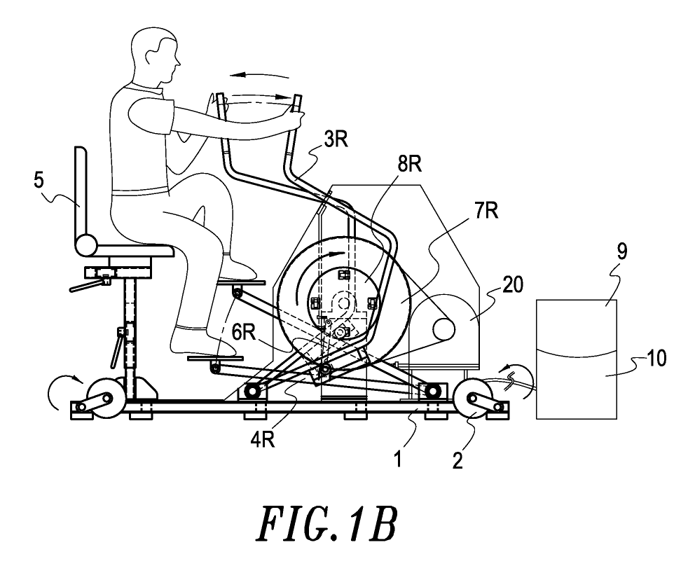

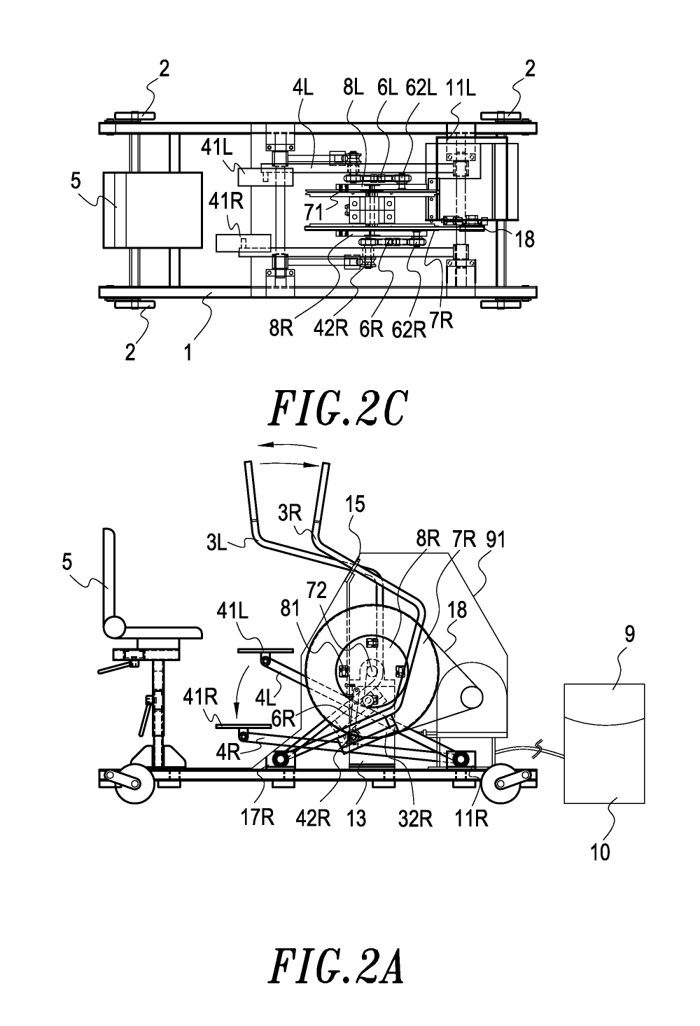

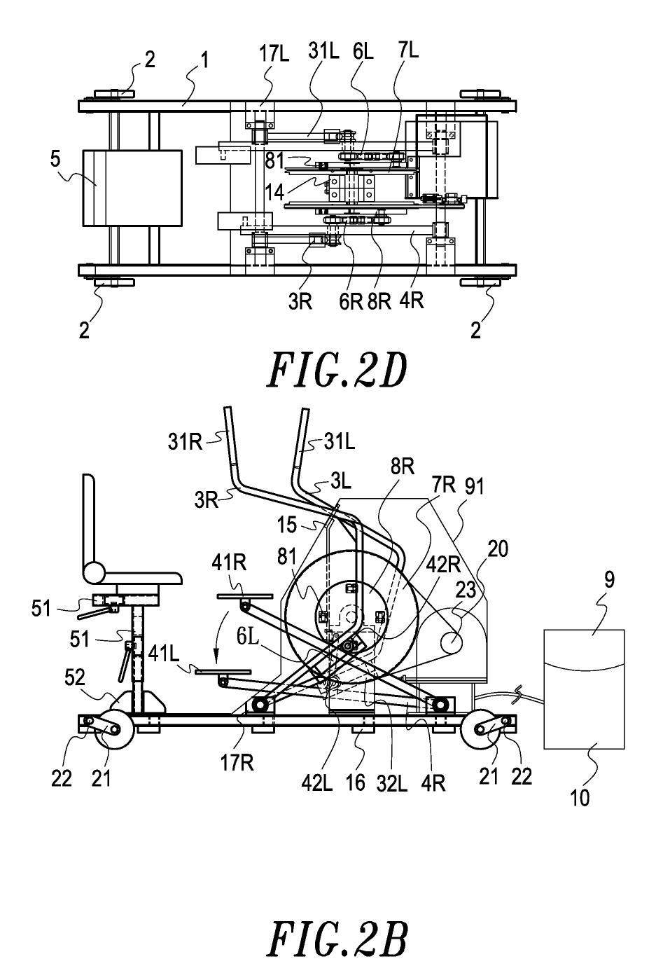

As shown in FIGS. 2A, 2B, 2C and 2D, the end of the hand pole sets 3R and 3L are pivoted to the hand pole rotation axis bases 17R and 17L respectively, and the end of the foot pole sets 4R and 4L are pivoted to the foot pole rotation axis bases 11R and 11L respectively. The foot pole rotation axis bases 11R and 11L, and the hand pole rotation axis bases 17R and 17L are adapted as stationary points refer to the hand pole sets 3R and 3L, and the foot pole sets 4R and 4L. By applying forces on the end of the hand pole sets 3R and 3L, and the foot pole sets 4R and 4L, the foot pole sets move upward and downward, as well as the hand pole sets move forward and backward. Via the position axes 42R and 42L pivoted to the foot pole sets 4R and 4L respectively, when the user gives force on the foot pole sets 4R and 4L, and give force on the hand pole sets 3R and 3L, the two kinds on forces concentrate on the position axes 42R and 42L and are transmitted to the linking pole sets 6R and 6L respectively. The linking pole sets 6R and 6L are separated with a shifted angle of 180 degree in advanced, thus the hand pole set 3R and the foot pole set 4R at the right side, and the hand pole set 3L and the foot pole set 4L at the left side are separated up and down with a shifted angle of 180 degree. And the shifted angle is due to that the ratchet adjustable axes 83R and 83L of the ratchet disk sets 8R and 8L respectively are separated with an angle of 180 degree and are opposite to each other. By the aforementioned structure, the hand pole sets 3R and 3L can always keep in a high position and a low position respectively, as well as the foot pole sets 4R and 4L. Thus, the hand pole sets 3R and 3L can be operated in a cycle, as well as the foot pole sets 4R and 4L. Particularly, when the foot pole set 4R is forced to move downward, it is adapted to drive the freewheel set 7R via the linking pole set 6R, and to push the foot pole set 4L back to the highest position for further operation. The foot pole set 4L cannot generate effective operation force when it is driven to move upward. When the hand pole set 3R is driven to move forward and backward, the operation promotes the linking pole set 6R via the position axis 42R of the foot pole set 4R. Then the freewheel set 7R is driven to rotate. The hand pole set 3R is configured to delivery driving force forward and backward, and is configured to push the hand pole set 3L back to the forefront position. At this time, the foot pole set 4L is driven to move upward and back to the highest position.

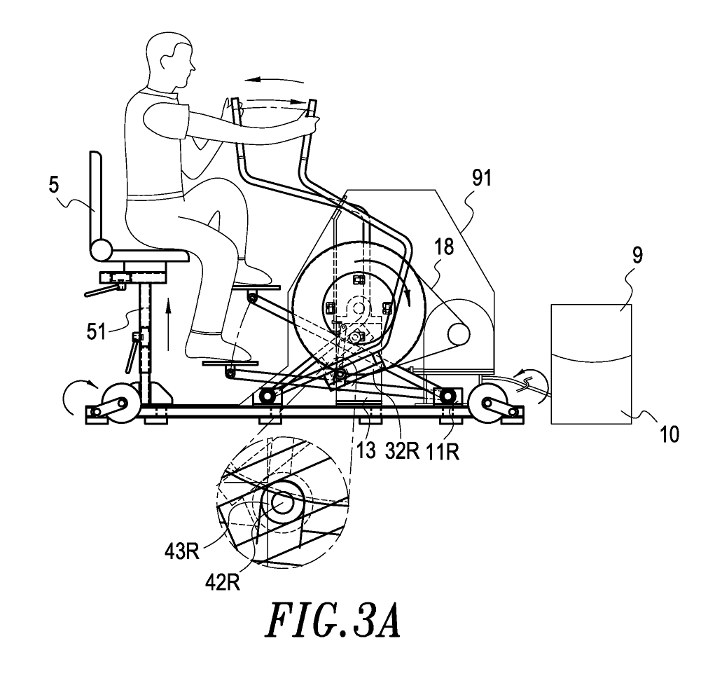

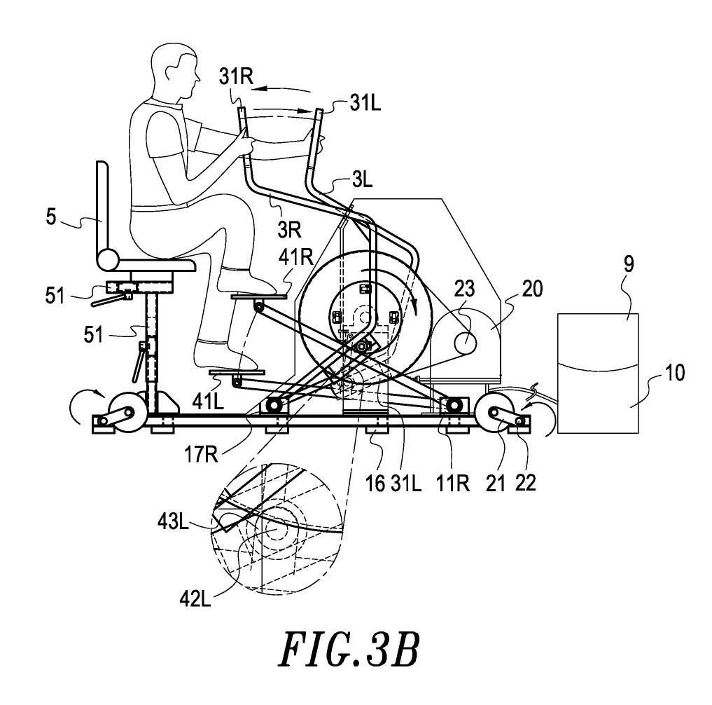

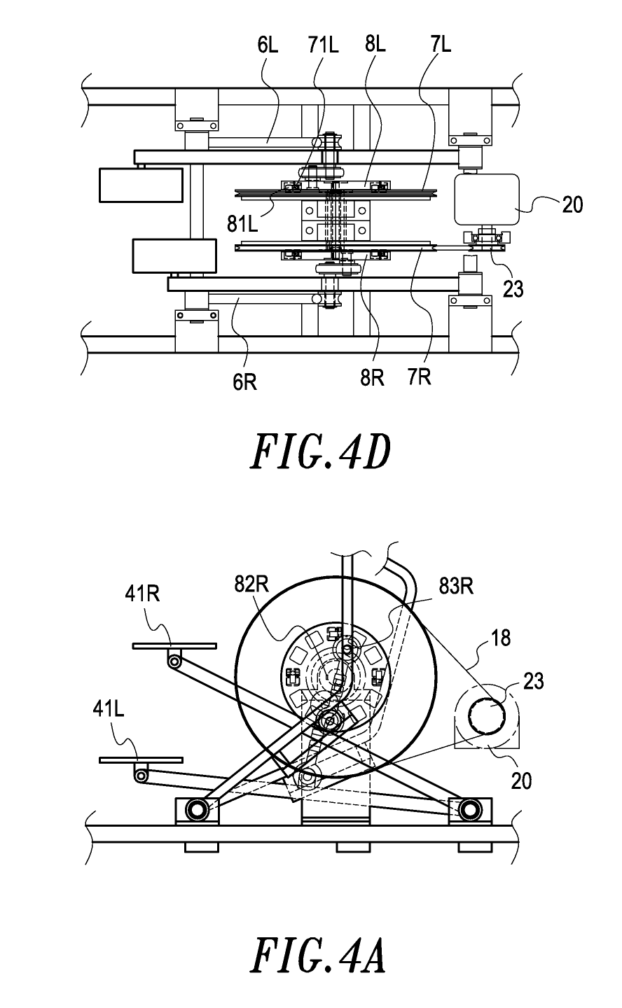

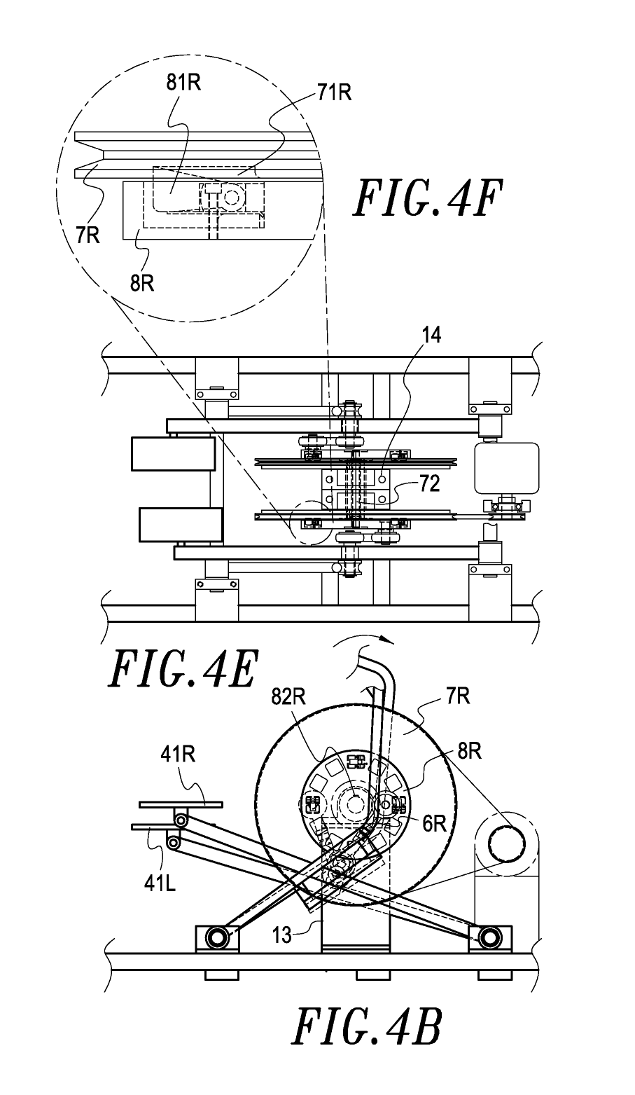

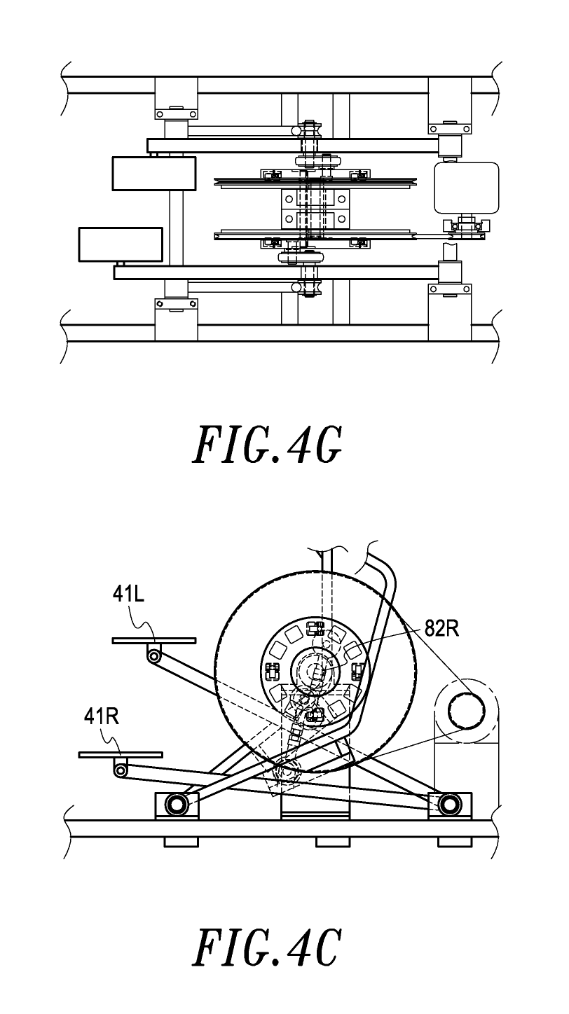

As shown in FIGS. 3A, 3B, and 4A-4G, when the present invention is operated, the linking pole 21 connected to the wheel set is moved upward and turned over for being fixed by taking the linking axis 22 as the center of a circle. And the rubber pad 16 at the pedestal is adapted to aligning the apparatus of the present invention, and is adapted to absorb shock and noise, and against sliding during operation. The seat set 5 is able to be adjusted by the expansion pole 51 thereof to fit different family members before operation.

FIGS. 3A, 3B, and 4A-4G show configurations of the present invention. When the right hand R of the user pushes the holder 31R of the hand pole set, and the right foot of the user pushes the pad 41R of the foot pole set, the guiding groove 32R of the hand pole set and the position axis 42R of the foot pole are jointly configured to drive the linking pole set 6R to drive the ratchet set 8R. The ratchet toothlike parts 81R of the ratchet set 8R is configured to drive the rabbets 71R of the freewheel 7R and to unidirectionally rotate the freewheel 7R. The transmission belt 18 is then driven by the freewheel 7R to operate the generator wheel 23. The generator wheel 23 is screwed on the arbor of the power generator 20 and is configured to generate power by rotation. The left hand and left foot respectively pushes the holder 31L and the pad 41L to drive the guiding groove 32L of the hand pole set and the position axis 42L of the foot pole. The guiding groove 32L of the hand pole set and the position axis 42L of the foot pole are jointly configured to drive the linking pole set 6L to drive the ratchet set 8L. The ratchet toothlike parts 81L of the ratchet set 8L is configured to drive the rabbets 71L of the freewheel 7L and to unidirectionally rotate the freewheel 7L. The transmission belt 18 is then driven by the freewheel 7L to operate the generator wheel 23. The power generator 20 is configured to generate power by rotation.

Since the ends of the hand pole sets 3R and 3L are pivoted to the hand pole rotation bases 17R and 17L for swinging, as well as the ends of the foot pole sets 4R and 4L are pivoted to the foot pole rotation bases 11R and 11L for swinging, the repeated operations can unidirectionally rotate the freewheel sets 7R and 7L respectively by the transmission mechanism made of the linking pole sets 6R and 6L, the ratchet toothlike parts 81R and 81L of the ratchet sets 8R and 8L, and the rabbets 71R and 71L of the freewheel sets 7R and 7L. Via the transmission belt 18, the freewheel sets 7R and 7L rotates in one direction to drive the generator wheel 23 of power generator 20 for converting the inputted mechanical energy into the electric energy. Then the electrical-control apparatus 9 is configured to convert the electric energy into proper electric energy for being stored in the battery 10. And a shell 91 is adapted to cover the pedestal 1 to protect the power generating configuration.

As shown in FIGS. 4A-4G, the ratchet wheel sets 8R and 8L are positioned by ratchet axis key rabbets 82R and 82L to separate ratchet disk adjustable axes 83R and 83L with a shifted angle of 180 degree. Therefore the pivoted left and right linking pole sets are adapted to be set with a shifted angle of 180 degree, and the left foot pole set 41L and the right foot pole set 41R are adapted to be set up-and-down with a shifted angle of 180 degree.

FIGS. 2A-2D, and 4A-4G show configurations of the present invention. One ends of the linking pole set 6R and 6L are respectively pivoted to the position axes 42R and 42L of the foot pole sets. One ends of the position axes 42R and 42L are respectively contained in the grooves 32R and 32L of the hand pole sets 3R and 3L. The hand pole sets 3R and 3L, and the foot pole sets 4R and 4L are configured to swing relatively to the rotation bases 11R, 11L, 17R, and 17L respectively. By the design of the present invention, solely driving the hand pole sets 3R and 3L or the foot pole sets 4R and 4L can unidirectionally rotate the freewheel sets 7R and 7L to generate electric energy. On the other hand, the user can take a rest of hands or feet, or temperately not to put forth strength when the freewheel rotates by its inertia. Thus the user can operate the apparatus of the present invention for a long time but not feel so tired. And the disabled person can also use the apparatus of the present invention by the feet or by the hands.

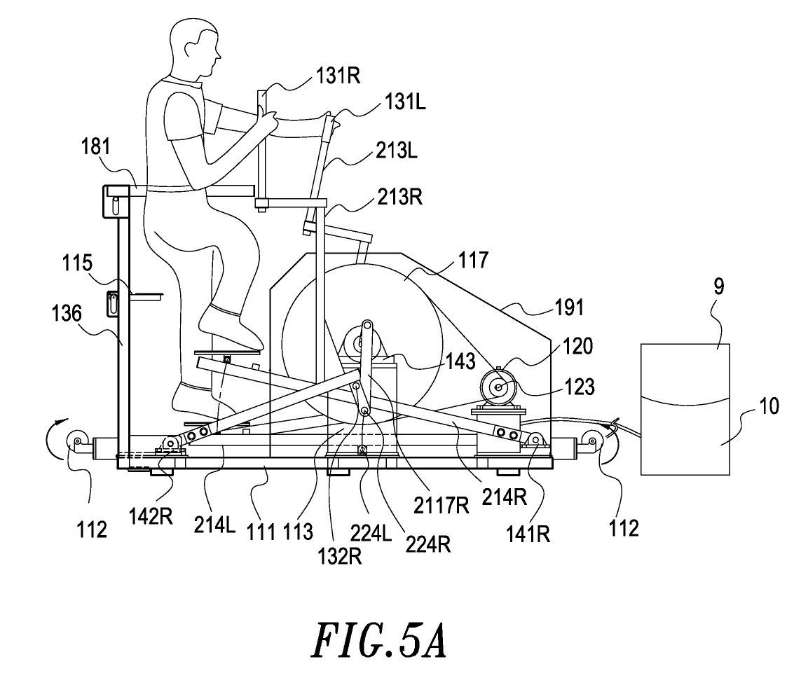

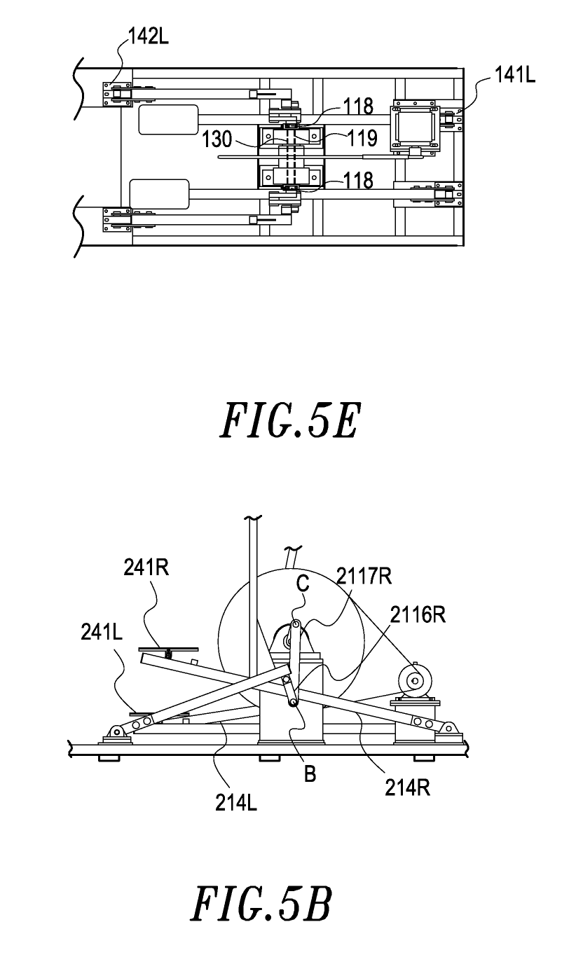

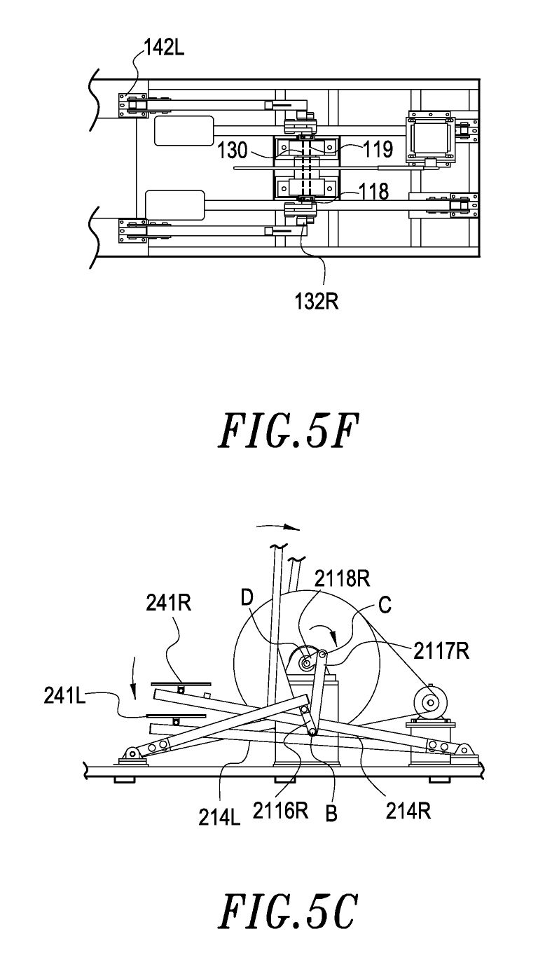

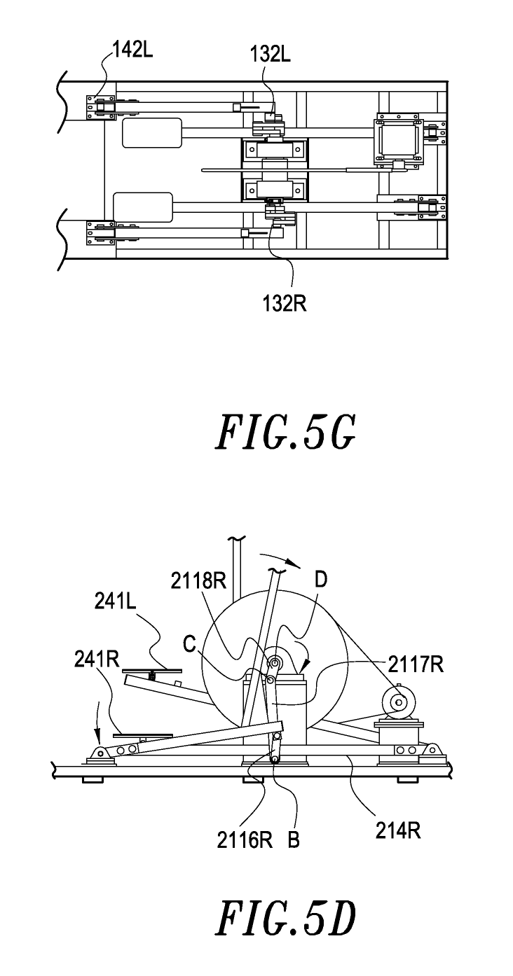

FIGS. 5A-5G shows another embodiment of the present invention, which comprises the following devices. The embodiment comprises a pedestal 111 having a power generator 120, a battery 10, a bearing base holder 113, a wheel set 112 being pivoted to the pedestal 111, foot pole sets 214R and 214L being respectively set with position axes 224R and 224L at middle portion thereof, in which the position axes 224R and 224L are pivoted to linking poles 2116R and 2116L, and 2117R and 2117L, the exterior linking poles 2116R and 2116L are pivoted to the position axes 132R and 132L of the hand pole sets, and the interior linking poles 2117R and 2117L are respectively pivoted to the upper linking poles 2118R and 2118L at one end thereof, and the pads 241R and 241L are connected to the foot pole sets 214R and 214L at the upper ends thereof respectively, and the rotation axes 141R and 141L of the pedestal 111 are connected to the foot pole sets 214R and 214L at the terminal ends thereof respectively.

The embodiment still comprises hand pole sets 213R and 213L being set next to and outside of the foot pole sets 214R and 214L respectively, in which upper portions of the hand pole sets 213R and 213L are holders 131R and 131L respectively, and position axes 132R and 132L are set at middle portions of the hand pole sets 213R and 213L respectively, the position axes 132R and 132L are pivoted to linking poles 2116R and 2116L respectively for connection with the foot pole sets respectively, and the terminal ends of the hand pole sets 213R and 213L are connected to the rotation axis bases 142R and 142L at another side of the pedestal 111. The embodiment still comprises a linking pole assembly consisting of a plurality of linking poles 2116R, 2116L, 2117R, 2117L, 2118R, and 2118L, in which one end of the linking poles 2118R and one end of the 2118L are screwed on the exterior end of a punching axis 130, and another end of the linking pole 2118R and another end of the linking pole 2118L are pivoted to the linking poles 2117R and 2117L respectively. The embodiment still comprises a unidirectional clutch 118 being installed inside of two ends of a holed axis 119, in which the holed axis 119 is installed inside the bearing base 143, and the punching axis 139 is configured to punch the holed axis 119 and be pivoted to two unidirectional clutches 118 therebetween, and the punching axis 139 has two screw ends extending outside the holed axis 119 for being screwed on ends of the linking poles 2118R and 2118L respectively.

The embodiment still comprises a freewheel 117 being pivoted to the external diameter of the holed axis 119 and fixed by the key rabbet, in which the holed axis 119 is pivoted to two bearing bases 143 there between, and the bearing bases 143 are screwed on the bearing base holder 113, and the bearing base holder 113 is screwed on the pedestal 111, thereby, by the rotational force transmitted via the linking poles, the punching axis 130 rotates and drives the unidirectional 118 to rotate in one direction and output force, and the holed axis 119 also rotates in one direction and drives the freewheel 117 to rotate in one direction, and a transmission belt set around the exterior rim of the freewheel 117 is adapted to transmit the rotational mechanical energy to the power generator 120.

The embodiment still comprises a power generator 120 being set on the pedestal 111, in which the power generator 120 has a power generator wheel 123 driven by the mechanical energy generated by the movement of the aforementioned mechanism via a transmission belt, and the power generator wheel 123 is screwed on the power generator 120 for rotating to generate power, and the generated power is integrated and controlled for being inputted and stored in a battery 10. The embodiment still comprises an electrical-control apparatus 9 being set next to the power generator 120 for integrating and controlling the power generated by the power generator.

The embodiment still comprises a battery 10 being set next to the power generator 120 and managed by the electrical-control apparatus 9, in which the battery 10 is configured to store the power from the power generator that is driven by the mechanical energy generated by the movement of the mechanism, and is configured to provide power to electrical appliances. The embodiment still comprises a seat 115 floatingly installed on a rear standing pole 136, in which the rear standing pole 136 is set on the pedestal 111 and a protection pole set 181 is set on the rear standing pole 136 at a upper end thereof. The seat 115 and the protection pole set 181 set on the rear standing pole 136 are configured to protect the user in sit-on pose or stand-up pose. A shell 191 is adapted to cover and protect the power generating configuration on the pedestal 111.

FIGS. 5A-5G further shows operations of the aforementioned mechanism of the linking poles 2116R, 2116L, 2117R, 2117L, 2118R, 2118L, the foot pole sets 214R and 214L, and the hand pole sets 213R and 213L. When the holders 131R and 131L of the hand pole sets 213R and 213L are pushed, or the pads 241R and 241L of the foot pole sets 214R and 214L are pushed, the position axes 224R and 224L are driven to move. The linking poles 2116 are connected to the position axes 224R and 224L (as the connection point B shows), another ends of the linking poles 2116 are driven by the hand pole sets 213R and 213L respectively, and the linking poles 2117 (as the connection point B shows) are driven by the foot pole sets 214R and 214L, and the hand pole sets 213R and 213L respectively. Then the linking poles 2117 transmit the force to the linking poles 2117r and 2117L at another end (as the connection point C shows), and the linking poles 2118R and 2118L are driven respectively. The linking poles 2118R and 2118L are screwed on the punching axis 130 (as the connection point D shows).

More, the punching axis 130 is adapted to punch through the holed axis 119, and two ends of the punching axis 130 are screwed on the linking poles 2118R and 2118L respectively, in which the linking poles 2118R and 2118L are separated with a shifted angle of 180 degree. Due to the shifted angle of 180 degree, the foot pole sets 214R and 214L, and the hand pole sets 213R and 213L are configured to operate smoothly in cycles when the user operates. The punching axis 130 is configured to transmit the rotation force to the holed axis 119 via the unidirectional clutch 118, then the holed axis 119 is configured to transmit the unidirectional rotation force to the freewheel 117 to rotate the freewheel in one direction for driving the power generator 120 to generate power. The main function of the unidirectional clutch 118 is configured to allow the user to take a short break but not continuously operate the mechanism. When the user temperately ceases adding force, the freewheel 117 continuously rotates by the rotation inertia to drive the power generator 120 to generate power.

Refer to the first embodiment, the ratchet toothlike parts 81R and 81L, and the rabbets 71R and 71L of the first embodiment, can be replaced with the unidirectional clutch 118 of the second embodiment that can be retrieved from the markets. And the unidirectional clutch 118 is also configured to allow the user take a short break during operation. And the ratchet disks 8R and 8L of the first embodiment, can be replaced by the linking poles 2118R and 2118L to save manufacturing cost and to keep outputting the same mechanical energy.

The present invention is not only suitable in daily household use or emergency power, but also suitable in sequent operations among many people for independent power generation. The present invention is suitable in being applied in the region that electric power supply is not so popularized. If the region is a calm zone or short of sunshine, wind energy or solar energy cannot be applied. If the region is far away from city, an island, a watch house, in the mountains, or closed to sea, the electric energy generated by power plant is hard to be delivered to. The present invention is suitable in city household that applies green power. To achieve manpower power generation, the apparatus of the present invention can be set indoor or outdoor. Then the manpower is adapted to drive mechanism. After the apparatus outputs the mechanical energy, the power generator operates to generate electric energy and provides electric power independently. Meanwhile, the user can go in for physical training. The experimental data of outputted mechanical energy of the present invention is as follows. An adult can output 30 Kg/second per one foot, and output 30 Kg/second pulsing weight. An adult can output 15 Kg/second per one hand. Summarily, an adult can output 45-65 Kg/second, then the output can be enlarged by applying level principle and be outputted to the power generator.

The aforementioned detail description is for explaining a particular embodiment of the present invention, and the embodiment is not applied to limit the present invention. The equivalent embodiment of modification after understanding the present invention shall be within the scope of the invention.

What is claimed is:

1. A manpower power generator, comprising:
a pedestal, being configured to provide supporting and connection for posterior configuration, in which the pedestal has a power generating apparatus, a battery, a rotation axis base, and a position base, the pedestal is configured to receive kinetic energy generated by the posterior configuration, and to convert the kinetic energy into electric power for storage and use;
a wheel set, being configured to be connected to the pedestal and a wheel axis via a linking pole;
a foot pole set, in which a position axis is set at central portion of the foot pole set, and a linking pole set is connected to the position axis at an end thereof, a pulley is set at the position axis at another end thereof, and a hand pole set is provided with a guiding groove for guiding a sliding force, a pad is connected to the foot pole set at an upper end thereof, and the rotation axis base is connected to the pedestal at the terminal end thereof;
the hand pole set, being set adjacently to and outside the foot pole set, in which the hand pole set is provided with a holding portion at the upper end of the hand pole set, and provided with a groove at the middle-down portion of the hand pole set, the groove is configured to provide space for a pulley to move forward and backward, the pulley is connected to the foot pole set, and the rotation axis base of the pedestal is connected to the hand pole set at the terminal end thereof;
a linking pole set, being made of a plurality of pole-end bearings and screwed poles, in which one end of the linking pole set is pivoted to a ratchet disk adjustable axis of the outside of a ratchet disk, and another end of the linking pole set is pivoted to the foot pole set at the position axis thereof;
a ratchet disk set, being set along a ratchet axis at two ends thereof, in which the ratchet axis passes through a freewheel axis hole, and is pivoted to a freewheel axis, a plurality of ratchet toothlike parts are set on the inside of the ratchet disk, and an axis hole for a movable ratchet disk axis is set on middle portion of the outside of the ratchet disk and pivoted to the linking pole set;
a freewheel set, in which a freewheel transmission axis is pivoted to a bearing base of the pedestal, a plurality of square rabbets are set on the middle portion of the outside of the freewheel, the rabbets are adapted to hold the ratchet toothlike parts for unidirectional rotation, and a transmission belt is set around an exterior rim of the freewheel for outputting the rotation mechanical energy to a power generator;
the power generator, being set on the pedestal, in which the power generator is configured to drive a generator wheel of the power generator by the mechanical energy via a transmission belt, the generator wheel is screwed on the power generator for rotating and generating power, and the generated power is integrated and stored in a battery;
a electrical-control apparatus, being set next to the power generator for integrating the power generated by the power generator;
the battery, being set next to the power generator and controlled by the electrical-control apparatus, in which the battery is configured to store the electrical power converted from the mechanical energy, and the mechanical energy is generated by movement of the mechanism, and the battery is configured to provide power to electric equipments; and
a seat set, being set on the position base of the pedestal via a expansion pole.

2. The manpower power generator as claimed in claim 1, wherein the ratchet is provided with a ratchet axis groove for positioning, and two ratchet adjustable axes of a left ratchet disk and a right ratchet disk are separated with an angle of 180 degree by the ratchet axis groove, and two pivoted linking pole sets are set with a shifted angle of 180 degree, thus the left foot pole set and the right foot pole set are adapted to be set up-and-down with a shifted angle of 180 degree.

3. The manpower power generator as claimed in claim 1, wherein the hand pole set is configured to drive the ratchet by the linking pole set, and the ratchet is configured to rotate to drive the freewheel, and the freewheel is configured to rotate and drive the power generator via a transmission belt.

4. The manpower power generator as claimed in claim 1, wherein the foot pole set is configured to drive the ratchet by the linking pole set, and the ratchet is configured to rotate to drive the freewheel, and the freewheel is configured to rotate and drive the power generator via a transmission belt.

5. The manpower power generator as claimed in claim 1, wherein inside of the ratchet disk is set with a plurality of ratchet toothlike parts for unidirectionally rotating the freewheel by driving the rabbets of the freewheel, and outside of the ratchet disk is connected to the linking pole set for receiving and converting the linear thrust of the linking pole set into rotational force.

6. The manpower power generator as claimed in claim 1, wherein the plurality of square rabbets are set on the outside of the freewheel, the square rabbets are adapted to receive unidirectional force and to rotate, the transmission belt is set around an exterior rim of the freewheel for outputting the rotation mechanical energy to a power generator, and the transmission belt is selected from groups of leather belts, chains, and gear wheels.

7. The manpower power generator as claimed in claim 1, wherein the wheel set is configured to be taken in the pedestal after the manpower power generator is moved to a fixed position.

8. The manpower power generator as claimed in claim 1, wherein the seat set has a expansion pole set, and the expansion pole set is configured to adjust the high or low position of the seat set.

9. A manpower power generator, comprising:
a pedestal, being configured to provide supporting and connection for posterior configuration, in which the pedestal has a power generating apparatus, a battery, a unidirectional bearing base, a bearing base, and a bearing holder, the pedestal is configured to receive kinetic energy generated by the posterior configuration, and to convert the kinetic energy into electric power for storage and use;
a wheel set, being configured to be connected to the pedestal and a wheel axis via a linking pole;
a foot pole set, in which a position axis is set at central portion of the foot pole set, and a linking pole set is connected to the position axis at an end thereof, a pad is connected to the foot pole set at the upper end thereof, and the rotation axis base is connected to the pedestal at the terminal end thereof;
a hand pole set, being set adjacently to and outside the foot pole set, in which the hand pole set is provided with a holding portion at the upper end of the hand pole set, and provided with a position axis at the middle-down portion of the hand pole set, the position axis is connected to a linking pole set, and the rotation axis base of the pedestal is connected to the hand pole set at the terminal end thereof;
a linking pole set, being made of a plurality of pole-end bearings and screwed poles, in which one linking pole of the linking pole set is connected to a punching axis inside a bearing base, and another end of the linking pole is pivoted to the foot pole set at the position axis thereof;
a unidirectional clutch, being installed at two sides of a unidirectional axis, in which the unidirectional axis is drilled to form a connection hole for the punching axis inside the bearing base to punch through, and the unidirectional axis is adapted to punch through the bearing base and a central-axis hole of a freewheel;
a freewheel set, being pivoted to the pedestal at a bearing base by the punching axis, in which the punching axis punches through the unidirectional axis, and the unidirectional axis is connected to the unidirectional clutch, and the freewheel set is configured to rotate in one direction by the guidance of the unidirectional clutch, and a transmission belt is set around an exterior rim of the freewheel for outputting the rotation mechanical energy to a power generator;
the power generator, being set on the pedestal, in which the power generator is configured to drive a generator wheel of the power generator by the mechanical energy via a transmission belt, the generator wheel is screwed on the power generator for rotating and generating power, and the generated power is integrated and stored in a battery;
a electrical-control apparatus, being set next to the power generator for integrating the power generated by the power generator;
the battery, being set next to the power generator and controlled by the electrical-control apparatus, in which the battery is configured to store the electrical power converted from the mechanical energy, and the mechanical energy is generated by movement of the mechanism, and the battery is configured to provide power to electric equipments; and
a seat set, being set on the position base of the pedestal via a expansion pole, in which a protection pole set is set at the expansion pole at the upper end thereof.

10. The manpower power generator as claimed in claim 9, wherein the linking poles at one end of the linking pole set are separated with a shifted angle of 180 degree and are pivoted to the punching axis inside the bearing base, and another end of the linking pole set is connected to the left hand pole set, the right hand pole set, the left foot pole set, and the right foot pole set, which are adapted to be set up-and-down with a shifted angle of 180 degree.

11. The manpower power generator as claimed in claim 9, wherein the linking pole at one end of the hand pole set is configured to drive the punching axis inside the bearing base and the unidirectional axis inside the unidirectional clutch to rotate, and the unidirectional axis inside the unidirectional clutch is configured to rotate and drive the freewheel to rotate, and the freewheel is configured to drive the power generator to rotate by the transmission belt.

12. The manpower power generator as claimed in claim 9, wherein the linking pole at one end of the foot pole set is configured to drive the punching axis inside the bearing base and the unidirectional axis inside the unidirectional clutch to rotate, and the unidirectional axis inside the unidirectional clutch is configured to rotate and drive the freewheel to rotate, and the freewheel is configured to drive the power generator to rotate by the transmission belt.

13. The manpower power generator as claimed in claim 9, wherein the seat set has a expansion pole set, and the expansion pole set is configured to adjust the high or low position of the seat set.
